(19) United States
(12) Patent Application Publication
(10) Pub. No.: US 2003/0118767 A1
(43) Pub. Date: Jun. 26, 2003

(54) Adhesive composition and improved rolled product employing adhesive composition

(75) Inventors: Duane G. Krzysik, Appleton, WI (US); Barbara Funk, Weyauwega, WI (US); Mary M. Zielinski, Boothwyn, PA (US)

Correspondence Address: John E. Vick, Jr., Dority & Manning, Attorneys at Law, P.A., P.O. Box 1449, Greenville, SC, 29602, US

(73) Assignee: Kimberly-Clark Worldwide, Inc.

(21) Appl. No.: 10/027,240

(22) Filed: Dec. 20, 2001

(51) Int. Cl. B32B 9/00; D02G 3/00; C04B 14/00

(52) U.S. Cl. 428/40.1; 106/812

(57) ABSTRACT

An adhesive composition and improved rolled product employing an adhesive composition is disclosed. Synthetic clays in combination with water soluble and dispersible thickeners may be useful for controlling the viscosity of adhesive formulations used in rolled paper product manufacture. The compositions may provide thixotropic properties, which are capable of shearing to a thin and sprayable viscosity, and then rapid thickening upon a surface of a rolled product. The rolled products to which the compositions may be employed may include tissues, towels, and the like. The compositions may be employed as tail sealing compositions adapted for securing the tail of a rolled web of product upon the roll, to avoid unraveling or undesirable unwinding of the roll before the product is used for its intended purpose upon manufacture.

### BACKGROUND OF THE INVENTION

In the manufacture of rolled products from webs of material, it is common to adhere the web to a core. It also is common to adhere the web to itself on the outer surface of the roll, as in the case of paper towels, bath tissue and the like. One reason for providing such a “tail seal” at the end of rolled products is to ensure that the product does not undesirably unravel prior to its use by the consumer.

Adhesives that have been employed in the tail sealing of rolled products sometimes have been found to be inadequate when such adhesives have been applied to modern highly absorbent and topically structured bath tissue and towels. For example, one highly absorbent tissue structure is known as uncreped through air dried (hereinafter designated as “UCTAD”), and such products are commercially manufactured and distributed widely. It sometimes has been found to be difficult to seal such webs in the tail seal process. In some instances, the adhesive penetrates too far into the sheet or web, causing a loss of adhesion properties, or in some instances, undesirable multi-ply adhesion.

One traditional resolution to such problems has been to increase the adhesive viscosity. However, increasing viscosity of such adhesives is difficult to control and regulate due to the changing environmental conditions, such as temperature and humidity. A low humidity condition, for example, sometimes may cause the adhesive to dry too quickly. A high humidity condition, on the other hand, sometimes prevents such adhesives from drying. Therefore, under such low humidity conditions the adhesive may not continue to absorb into the sheet because of premature drying. Likewise, at high humidity conditions, the adhesive may not dry quickly enough. If this occurs, then the adhesive may undesirably penetrate too far into the sheet.

What is needed in the industry is an adhesive that provides a relatively flat temperature/viscosity curve. An adhesive that exhibits a thixotropic (i.e. a shear thinning) viscosity would be desirable. An adhesive that is generally hydroscopic in nature, and is capable of holding a limited amount of water for tail seal adhesion would be desirable. An adhesive that is capable of drying quickly so as to avoid excess penetration into the sheet also would be desirable.

### SUMMARY OF THE INVENTION

The invention provides novel adhesive compositions and improved rolled products employing such adhesive compositions. For example, a rolled sheet product is provided having a first sheet with a first end and second end. The first end of the sheet may be provided near the center of the roll (i.e. for instance at a core) while the second end of the sheet is secured to the outer circumferential surface of the roll. The second end may be secured with an adhesive composition comprising a thixotropic colloidal composition. In some cases, a clay or a synthetic clay may be used. In other applications, a silicate may be employed. Many of the silicates that may be employed comprise crystal structures with multiple layers.

In one application of the invention, a LAPONITE® composition may be employed comprising a magnesium silicate. The magnesium silicate may be layered and/or hydrous, in some instances.

Such compositions may be adapted for securing the end of a rolled web product. Furthermore, such compositions may comprise in part a synthetic mineral formed by combining sodium, magnesium, or lithium with a sodium silicate. In some applications, a synthesized or crystallized structure comprises magnesium ions that are bonded to silicon atoms. A colloid may be employed in the practice of the invention.

### BRIEF DESCRIPTION OF THE DRAWINGS

A full and enabling disclosure of this invention, including the best mode shown to one of ordinary skill in the art, is set forth in this specification. The following Figures illustrate the invention:

FIG. 1 is a perspective view of a rolled paper product; and

FIG. 2 shows the attachment of a paper web to a cylindrical core.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents.

Surprisingly, it has been discovered that certain types of clays, synthetic clays and water soluble dispersible thickeners disclosed herein are useful for controlling the static viscosity of adhesive formulations in application to rolled products. Such compositions have the property of being thixotropic, in which the adhesive formulation under shear pressure is capable of thinning to a sprayable viscosity, but also is capable of quickly thickening upon the surface of a tissue or towel to avoid excess penetration into the sheet.

Thus, increasing the viscosity of such adhesives improves the tail sealing ability of the adhesives. The invention recognizes a novel approach of thixotropic viscosity enhancement colloid coupled with an appropriate hydrophobic water soluble adhesive resin and optionally an additive to control wet tack.

Essentially any adhesive resin can be employed with the colloid. Numerous adhesive resins manufactured by National Starch and Chemical Company of Bridgewater, New Jersey may be employed. For example the following products manufactured by National Starch are believed to be capable of application in the invention: TISSUE-LOK® 18-346A and 18-347A; TISSUE-TAK® 18-3502; TISSUE-TAK® 18-3503; TISSUE-TAK® 18-3504; TISSUE-TAK® 18-3505; TISSUE-TAK® 18-3510 AND 18-3511 AND 18-351A, 18-500A; TISSUE-TAK® 71-4673, 71-4789, 71-4877, 71-4893, and others. Other products manufactured by National Starch & Chemical Co. or other adhesive suppliers may be employed as well, and the invention is not limited to any particular adhesive composition, supplier, or brand.

National Starch & Chemical Company products TISSUE-LOK® 18-346A and 18-347A are known to perform well in the application of the invention.

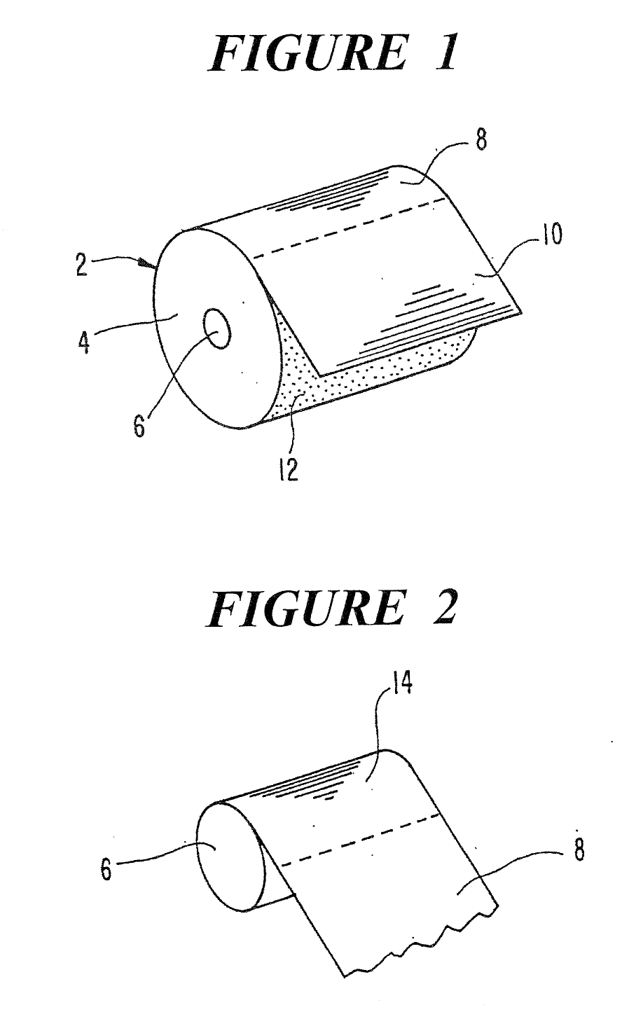

Referring now to FIG. 1 and FIG. 2, a rolled product 2 consists of a cylindrical core 6 about which the roll body 4 is wound. The last sheet or tail 10 of the paper web 8 is to be bonded to roll body 4 by means of a non-continuous discreet deposition of adhesive 12 upon the paper web 8, or the core 6. That is, adhesive may be used to secure the paper web 8 to the core 6, as well as to secure the paper web 8 to itself on the outer diameter of the rolled product 2.

A rolled product 2 includes a first end of the paper web 8 (as seen in FIG. 2) which optionally may be attached to a core 6. Furthermore the second end or tail 10 is seen in FIG. 1. The roll body 4 provides a curved outer circumferential surface of the roll body 4. As seen in FIG. 1, the first end of the paper web 8 is near the center of the roll (or optionally attached to core 6) and the second end is secured to the outer circumferential surface of the rolled product 2. The second end (i.e.: tail 10) may be secured by adhesive composition 12 which may contain a thixotropic colloidal composition, as further detailed below. The use of a core 6 is entirely optional, and the compositions of the invention also may be applied to tail sealing of coreless rolls as well (coreless rolls not shown).

Several United States patents disclose roll rewinder transfer apparatus and methods, portions of which could be applied in rolling products in the practice of the invention, for sealing the tail in rolled paper product manufacture. U.S. Pat. No. 3,791,602 to Isakson discloses a method and apparatus for sheet transfer from one roll to another succeeding roll. U.S. Pat. No. 3,994,396 to Reilly et al. discloses an adhesive composition for tail control including a modified starch, polyethylene resin, and water.

On the other hand, in the application of this invention thixotropic compositions are employed. In general, a thixotropic composition is defined as a colloidal gel capable of liquefying when agitated as by shaking, mixing, or with ultrasonic vibration. Such thixotropic compositions are capable of returning to the gel form when at rest. For example, this property is observed in some cosmetics, paints, and printing inks that flow freely on application of relatively slight pressure, as by brushing or rolling.

Suspensions of bentonite clay in water also display thixotropic properties. Thus, it is possible to apply in the practice of the invention a thixotropic viscosity enhancing composition in addition to an adhesive resin. In one application of the invention, a clay composition may be employed. That is, either a natural clay or a synthetic clay (such as a bentonite or hectorite) may be employed. In some applications such composition may be a magnesium silicate, or a magnesium aluminum silicate. Preferably, in the case of a magnesium silicate, it should be free from natural clay impurities and processed under controlled conditions.

Other clays that may be employed in the practice of the invention, include, but are not limited to, montmorillonite, kaolinite, bentonite, halloysite, attalpulgite, illite, beidellite, hectorite, scaponite, and sterenite.

Some particularly useful synthetic compositions that may be employed in the invention are known as LAPONITE®. “LAPONITE” is believed to be a registered trademark for a series of synthetic clays, and the trademark is believed to be registered to Laporte Industries Limited of the United Kingdom, 3 Bedford Square, London, England. Such LAPONITE® products may be synthesized by combining salts of sodium, magnesium and lithium with sodium silicate, for example. This reaction produces an amorphous precipitate, which is then impartially crystallized by a high temperature treatment. The resulting product is filtered, washed, dried and milled to give a fine white powder.

LAPONITE® exhibits a layered structure which, in dispersion in water, is in the form of synthetic disc-shaped crystals. It can be seen as a two-dimensional inorganic polymer. Some compositions of this type show as many as six octahedral magnesium ions sandwiched between two layers of tetrahedral silicon atoms. These groups may be balanced by as many as about 20 oxygen atoms and about 4 hydroxyl groups. The height of a unit cell represents the thickness of the crystal formed. The unit cell may be repeated many times in two directions, resulting in the disc-shaped appearance of the crystal. A typical crystal may contain about 25,000-45,000 unit cells. Macromolecules of this particle size are sometimes known as “colloids”.

Natural clay thickeners such as bentonite and hectorite also have a similar disc shaped crystal structure but are an order of magnitude larger in size. Natural clay also may be employed in the practice of the invention.

In general, a high viscosity colloidal dispersion is termed a “gel”. Also, a low viscosity colloidal dispersion is termed a sol. It is possible to modify LAPONITE® from a gel-forming type to a sol-forming type by addition of certain compounds, for example, condensed phosphates, polyethylene glycols, polypropylene glycols and certain non-ionic surfactants. Optimized sol-forming grades have been developed by combining such LAPONITE® with a small proportion of tetrasodium pyrophosphate. LAPONITE® is a layered hydrous magnesium silicate which is free from natural clay impurities and is synthesized under controlled conditions.

To obtain the best performance from LAPONITE® in any such compositions, it should be dispersed and fully hydrated in the free water before use. Failure to do so may sometimes result in a much slower viscosity build or a reduced efficiency. Such materials usually will function in fully formulated compositions over a broad pH range from about 3 to about 13.

LAPONITE® products also are distributed by Southern Clay Products, Inc. of 1212 Church Street, Gonzales, Tex. 78629. For example, several products known as LAPONITE® XLS, LAPONITE® LXG, GELWHITE MAS 100®, GELWHITE H,NF® and MINERAL COLLOID BP® also may be employed as thixotropic agents in the practice of the invention. Any of these products may be employed in the practice of the invention, as previously described.

In most applications, LAPONITE® is synthesized under carefully controlled conditions to ensure consistency from batch to batch. In general, LAPONITE® comprises a colloidal synthetic layered silicate.

In this specification, reference is made to “colloid” or “colloidal” to refer to a very small particle, which often may be a macromolecule. In general, a colloid has a particle size which is less than about 500 nanometers. Furthermore, the term “gel” refers to a high viscosity colloidal dispersion. On the other hand, a “sol” usually refers to a low viscosity colloidal dispersion. Gel grades of LAPONITE® usually disperse readily in water, under agitation, to form clear, colorless dispersions. At concentrations ranging from about 0.2% to about 2% by weight in tap water, highly thixotropic gels may be formed. When a sol grade of LAPONITE® is employed, the same dispersion characteristics may be observed, but it also may be desirable to incorporate into the composition an inorganic polyphosphate dispersing agent. Such an inorganic polyphosphate dispersing agent may act to delay the formation of a thixotropic gel structure.

Without being limited to the specific mechanism or mode of operation, it is believed that electrostatic attractions draw ions towards the crystal surface. Furthermore, osmotic pressure from the bulk of water may pull them away. An equilibrium may become established wherein such ions (i.e. such as sodium ions) are held in a diffuse region on both sides of a dispersed LAPONITE® crystal.

Furthermore, the addition of polar compounds in solution, such as simple salts, surfactants, coalescing solvents, soluble impurities and additives in pigments, fillers or binders, to a dispersion of LAPONITE® may reduce the osmotic pressure holding the sodium ions away from the particle surface. In some cases, this may cause the electrical double layer to thin, thereby allowing the weaker positive charge on the edge of the crystal to interact with the negative surfaces of adjacent crystals. The invention is not limited, however, to any particular mode of action.

Other compositions that may be employed in the practice of the invention include smectite clays that have been water washed to optimize purity and performance. Furthermore several different products distributed by the R. T. Vanderbilt Company, Inc. may be employed in the practice of the invention. These products include VEEGUM® and VANGEL® (VEEGUM® and VANGEL® are registered trademarks of R. T. Vanderbilt Company, Inc.). VEEGUM® and VANGEL® comprise natural smectite clays. These compositions may be employed to stabilize suspensions, and optimize flow properties.

VEEGUM® and VANGEL® products often are used with organic thickeners. The viscosity or stability of formulations containing such mixtures may be greater than the viscosity or stability of the same formulation made with the individual components of the mixture. Such combinations facilitate the fine tuning of the viscosity and flow properties beyond what may be possible with either a clay or an organic thickener alone. Examples of organic thickeners that may be employed include polyacrylates, carbomers, sodium carboxymethylcellulose, hydroxyethyl cellulose, hydroxypropyl cellulose, hydroxypropylmethylcellulose, methylcellulose, xanthan gum, sodium carageenan, sodium alginate, hydroxypropyl guar, gum Arabic, and gum tragacanth. Such organic thickeners may be employed in a weight-to-weight ratio range of VEEGUM® or VANGEL® to thickener ranging from about 10:1 to about 1:1, or less.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. A rolled sheet product, comprising:
a first sheet, said first sheet having a first end and a second end, the sheet being wound into a roll, the roll having an outer circumferential surface, wherein the first end of the sheet is near the center of the roll, and the second end of the sheet is secured to the outer circumferential surface of the roll, wherein the second end is secured with an adhesive composition, the adhesive composition comprising a thixotropic colloidal composition.

2. The product of claim 1 in which the thixotropic colloidal composition comprises a natural clay.

3. The product of claim 2 in which the clay is selected from the group of clays comprising: montmorillonite, kaolinite, bentonite, halloysite, attalpulgite, illite, beidellite, hectorite, scaponite, sterenite.

4. The product of claim 1 in which the thixotropic colloidal composition comprises a synthetic clay.

5. The product of claim 1 in which the thixotropic colloidal composition comprises in part a synthetic silicate.

6. The product of claim 5 in which the synthetic silicate exhibits a crystal structure.

7. The product of claim 5 in which the synthetic silicate comprises a layered structure.

8. The product of claim 1 in which the thixotropic colloidal composition comprises a magnesium silicate.

9. The product of claim 8 in which the magnesium silicate comprises a magnesium aluminum silicate.

10. The product of claim 1 in which the thixotropic colloidal composition employed comprises from about 0.2 to about 2% thixotropic colloidal species by weight of the adhesive composition.

11. The product of claim 10 in which the thixotropic colloidal composition employed comprises a silicate.

12. The product of claim 11 in which the silicate employed comprises a magnesium silicate.

13. A sealing composition adapted for securing the end of a rolled web product, the composition comprising in part a synthetic mineral that is formed by combining:
(a) a salt from the group of salts comprising: sodium, magnesium, and lithium, and
(b) sodium silicate.

14. A tail sealing composition adapted for securing the tail of a rolled web product, the composition comprising, in part, a colloidal dispersion that is capable of both: (1) thickening the composition into a gel, and (2) thinning the composition into a sol.

15. A tail sealing composition adapted for securing the tail of a rolled web product, the composition comprising in part a silicate.

16. The composition of claim 15 in which the silicate comprises a layered magnesium silicate.

17. The composition of claim 16 in which the layered magnesium silicate comprises a layered hydrous magnesium silicate.

18. The composition of claim 15 in which the layered hydrous magnesium silicate is provided in a concentration by weight of about 0.2 to about 2%.

19. An additive formulated for introduction into an aqueous adhesive composition, the adhesive composition being adapted for securing the end of a web in a rolled web product, wherein the additive comprises, in solution, a synthetic crystallized silicate structure.

20. The additive of claim 19 in which the synthetic crystallized structure comprises magnesium ions bonded to silicon atoms.

21. An adhesive composition adapted for securing together paper sheets in a paper manufacturing process, wherein the composition comprises a colloid.

22. The composition of claim 21 in which the colloid comprises in part a synthetic silicate.

23. The composition of claim 22 in which the synthetic silicate comprises in part a crystal.

24. The composition of claim 23 in which the synthetic silicate comprises a synthetic layered silicate.

25. The composition of claim 21 in which the colloid comprises a magnesium silicate.

26. The composition of claim 25 in which the magnesium silicate comprises in part a layered hydrous magnesium silicate.

27. The composition of claim 25 in which the magnesium silicate comprises from about 0.2 to about 2% by weight of the adhesive composition.

28. A rolled substrate material product comprising a web of substrate material rolled onto a cylindrical core, the tail of said rolled substrate material being releasably bonded to the roll by a non-continuous layer of an adhesive composition, the composition comprising a colloid.

29. The product of claim 28 in which the colloid comprises a synthetic silicate.

30. The product of claim 29 in which the synthetic silicate comprises a crystal.

31. The product of claim 30 in which the synthetic silicate comprises a layered structure.

32. The product of claim 28 in which the colloid comprises a magnesium silicate.

33. The product of claim 32 in which the magnesium silicate comprises in part a layered hydrous magnesium silicate.
